(19) United States
(12) Patent Application Publication
(10) Pub. No.: US 2017/0040627 A1
(43) Pub. Date: Feb. 9, 2017

(54) FUEL CELL SYSTEM AS WELL AS A VEHICLE HAVING SUCH A FUEL CELL SYSTEM

(71) Applicant: Volkswagen AG, Wolfsburg (DE)

(72) Inventors: Maren Ramona Kirchhoff, Braunschweig (DE); Nadine Rink, Wolfsburg (DE); Maik Moebius, Wolfsburg (DE); Frank Juergen Engler, Wolfsburg (DE)

(21) Appl. No.: 15/228,233

(22) Filed: Aug. 4, 2016

(30) Foreign Application Priority Data
Aug. 5, 2015 (DE) DE102015214956.0

(51) Int. Cl. H01M 8/04664; H01M 8/04089; C23F 13/08; H01M 8/04029; H01M 8/04992

(52) U.S. Cl. CPC H01M 8/04686; H01M 8/04029; H01M 8/04992; C23F 13/08; H01M 8/04097; H01M 2250/20

(57) ABSTRACT

A fuel cell system (100) having a fuel cell stack (10) and a fuel cell cooling system (40) to cool the fuel cell stack (10), including a coolant path (4) into which the fuel cell stack (10) is integrated so as to transfer heat and in which at least one cooler (43) or heat exchanger is arranged. It is provided that the at least one cooler (43) or heat exchanger that does not have shock-hazard protection is interconnected so as to establish equipotential bonding (47), whereby at least one control element is arranged in the connection of the at least one cooler (43) or heat exchanger to equipotential bonding (47). Moreover, a vehicle having such a fuel cell system (100) is disclosed.

This claims the benefit of German Patent Application DE 10 2015 214 956.0, filed Aug. 5, 2015 and hereby incorporated by reference herein.

The invention relates to a fuel cell system having a fuel cell stack and a fuel cell cooling system to cool the fuel cell stack, comprising a coolant path into which the fuel cell stack is integrated so as to transfer heat and in which at least one cooler or heat exchanger is arranged, and it also relates to a vehicle.

### BACKGROUND

Fuel cells utilize the chemical reaction of a fuel with oxygen to form water in order to generate electric energy. For this purpose, the fuel cells have, as their core component, the so-called membrane electrode assembly (MEA), which is a structure consisting of an ion-conductive (usually proton-conductive) membrane and an electrode (anode and cathode) arranged on each side of the membrane. Moreover, it is also possible to arrange gas diffusion layers (GDL) on both sides of the membrane electrode assembly on the sides of the electrodes facing away from the membrane. As a rule, the fuel cell is formed by a plurality of stacked MEAs whose electric outputs are cumulative. As a rule, there are bipolar plates (also called flow field plates) arranged between the individual membrane electrode assemblies and they serve to ensure that the individual cells are supplied with the operating media, in other words, the reactants, in addition to which they also normally serve for cooling purposes. Moreover, the bipolar plates establish an electrically conductive contact with the membrane electrode assemblies.

During the operation of the fuel cell, the fuel cell reaction generates heat, which is why the fuel cell stack is integrated into a cooling circuit that discharges the waste heat via a coolant. The coolant is cooled, for example, by means of an air cooler; in the case of a vehicle, this is normally a radiator.

In the fuel cell stack, the coolant in the circulation system of fuel cell systems comes into contact with the high-voltage potentials. At the same time, the coolant flows through various components whose housing is connected to the frame such as, for example, a high-voltage coolant pump. If the coolant has a high conductivity, the insulation resistance drops between the appertaining high-voltage potentials and ground. Therefore, in order to maintain a high insulation resistance, care must be taken to ensure that components with ground contact are at a sufficiently large distance from the high-voltage potentials. At the same time, a low coolant conductivity has to be ensured, for example, by means of deionization filters. If the coolant conductivity becomes too high, an insulation resistance monitoring system of a vehicle will detect this as an insulation fault.

According to the state of the art, the vehicle is not switched off in case of an insulation fault, and therefore, it must be ensured that there is no risk to persons during the time between the detection of the insulation fault and the remedying of the fault. In the case of high-voltage components, various measures ensure the high-voltage safety. For example, the housing—which is connected to ground and which cannot be opened without a tool or which is secured by an interlock (lock to prevent mechanical damage or harm to humans)—in conjunction with appropriate warning signs, forms the shock-hazard protection aimed at ruling out risks.

In the fuel cell-powered vehicle, the components in the coolant circuit of the fuel cell system that do not fall into the category of high-voltage components should also be viewed in a similar manner.

These are components that functionally do not call for equipotential bonding to the ground and that are positioned in close proximity to the high-voltage potentials. They are configured or installed so as to be electrically insulated, for example, using protective covers or the like that cannot be removed, thereby ensuring shock-hazard protection.

For components that functionally do not call for equipotential bonding, there are two possibilities for ensuring shock-hazard protection, which is only needed in case of an insulation fault: shock-hazard protection (electric insulation) or connection of all conductive parts to ground.

Although the radiator in the front of the vehicle does not call for equipotential bonding, it is so readily accessible, either from the outside or when the hood is opened, that equipotential bonding is the technically simpler and more sensible approach to ensure that it is completely inaccessible to persons, especially since shock-hazard protection, for example, the use of protective covers, results in a reduction of the cooling performance.

In contrast, radiators are made of less noble metals nowadays than the other components in the coolant circuit, so that if equipotential bonding is established, then corrosion of the radiator and thus material wear and tear, replacement costs and a continuously higher input of ions into the coolant can all be expected over the course of time.

German patent application DE 26 31 113 A1 describes, for example, a fuel cell cooling system that has sacrificial electrodes for a coolant in order to attain protection against corrosion at the inlets and outlets of the fuel cell.

### SUMMARY OF THE INVENTION

It is an object of the present invention to provide a fuel cell system having a fuel cell cooling system that comprises a radiator by means of which corrosion of the radiator is greatly reduced as compared to the state of the art.

A fuel cell system is provided having a fuel cell stack and a fuel cell cooling system to cool the fuel cell stack, comprising a coolant path into which the fuel cell stack is integrated so as to transfer heat and in which at least one cooler or at least one heat exchanger is arranged. In this context, according to the invention, the at least one cooler or the at least one heat exchanger is interconnected to equipotential bonding, whereby at least one control element is arranged in the connection of the at least one cooler or at least one heat exchanger to equipotential bonding. The control element activates or deactivates the connection of the at least one cooler or at least one heat exchanger to equipotential bonding.

Even if mention is only made of the cooler below, this nevertheless also refers to the heat exchanger. Suitable heat exchangers are known to the person skilled in the art.

Thus, it is advantageously possible to control the duration of the connection of the at least one cooler to equipotential bonding. Advantageously, equipotential bonding only has to be present on the at least one cooler if there is a need for this. Thus, the corrosion that occurs during equipotential bonding due to the fact that the at least one cooler is normally made of less noble metal than the other components in the fuel cell system is markedly diminished since, during the operating times of the fuel cell system when there is no need for equipotential bonding, the latter is suppressed by the at least one control element.

A need for equipotential bonding of the at least one cooler exists, for example, if an insulation fault occurs in the cooling system of the fuel cell system. Therefore, according to a preferred embodiment of the invention, a control of the at least one control element is provided for the temporary connection of the cooler to equipotential bonding by means of a control unit, preferably a system control unit, of the fuel cell system that has means for the detection of insulation faults in the cooling system. Thus, if an insulation fault is detected in the cooling system, the at least one cooler is advantageously connected in order to establish equipotential bonding, so that corrosion is only possible until the next visit to the repair shop to remedy the insulation fault. Moreover, risk to persons is ruled out in the meantime.

In other situations, it is also advantageous to provide equipotential bonding. For instance, the conductivity of a coolant after a long standstill time is often higher than during regular operation. As a result, a system control can also establish equipotential bonding on the basis of an evaluation of the standstill time of the coolant. The equipotential bonding can be deactivated after the evaluation of an insulation measurement, for example, after the operating temperature of the coolant has been reached.

Moreover, equipotential bonding can be necessary if components in the cooling system have been replaced since they can have an elevated ion output due to impurities and this, in turn, leads to a reduced insulation resistance. The equipotential bonding can then, in turn, be deactivated after the evaluation of the insulation measurement. Consequently, even after maintenance work on the cooling system, an elevated insulation resistance can be permitted for a limited time, as a result of which, for example, the cleaning of components before their installation can advantageously be reduced or simplified or else even eliminated altogether.

The at least one control element is preferably an electrically switching component that, in turn, is preferably a relay. Other suitable electrically switching components are known to the person skilled in the art. The number of control elements to be used is evident to the person skilled in the art by taking into account the specific fuel cell system and the cooler(s) or heat exchanger(s) located therein.

According to an especially preferred embodiment, the at least one cooler is additionally provided with at least one sacrificial anode that is then interconnected, together with the at least one cooler, to equipotential bonding as a function of the control element. Due to this advantageous configuration of the fuel cell system according to the invention, it is possible to effectively prevent corrosion of the at least one cooler, even during operating phases in which equipotential bonding is present. A replacement of the at least one sacrificial anode is more favorable and easier to undertake than the replacement of a corroded cooler. Since a deionization filter for the coolant is preferably provided in the fuel cell system or arranged in the cooling system, this filter should be configured appropriately for the ion input into the coolant that is brought about by the at least one sacrificial anode.

Another aspect of the present invention relates to a vehicle that has a fuel cell system according to the present invention. In this context, the fuel cell system especially serves to supply power to an electric drive aggregate of the vehicle or to charge a battery.

The various embodiments of the invention cited in this application can be advantageously combined with each other, unless otherwise indicated in individual cases.

### BRIEF DESCRIPTION OF THE DRAWINGS

The invention will be described below by means of an embodiment on the basis of the accompanying drawings. The following is shown:

FIG. 1 a flow diagram of a fuel cell system.

### DETAILED DESCRIPTION

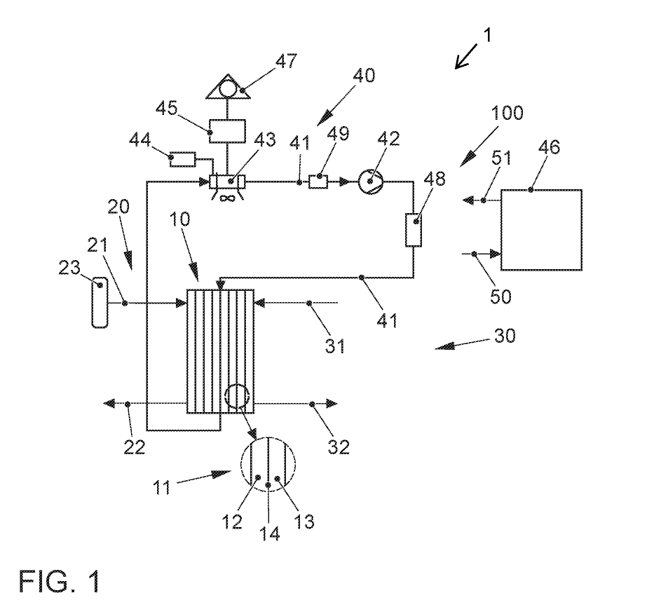

FIG. 1 shows a fuel cell system designated in its entirety by the reference numeral 100. The fuel cell system 100 is part of a vehicle 1 (referenced schematically), especially an electric vehicle, which has an electric traction motor that is supplied with electric energy by the fuel cell system 100.

The fuel cell system 100 has, as its core component, a fuel cell stack 10 with a plurality of stacked cells 11, each of which comprises an anode space 12 as well as a cathode space 13, which are separated from each other by an ion-conductive polymer electrolyte membrane 14 (see detailed cutout view). Between two such membrane electrode units, there is also a bipolar plate that serves to feed the operating media into the anode and cathode spaces 12, 13 and that also establishes the electric connection between the individual fuel cells 11. In order for the fuel cell stack 10 to be supplied with the operating gases, the fuel cell system 100 has an anode supply system 20 on the one hand, and a cathode supply system 30 on the other hand.

The anode supply system 20 comprises an anode supply path 21 that serves to feed an anode operating gas (the fuel), for example, hydrogen, into the anode space 12 of the fuel cell stack 10. For this purpose, the anode supply path 21 connects a fuel reservoir 23 to an anode inlet of the fuel cell stack 10. The anode supply system 20 also comprises an anode exhaust gas path 22 that discharges the anode exhaust gas out of the anode spaces 12 via an anode outlet of the fuel cell stack 10. Moreover, the anode supply system 20 can have a fuel recirculation line that connects the anode exhaust gas path 22 to the anode supply path 21. The cathode supply system 30 comprises a cathode supply path 31 that feeds a cathode operating gas containing oxygen, especially air, into the cathode spaces 13 of the fuel cell stack 10.

The cathode supply system 30 also comprises a cathode exhaust gas path 32 that discharges the cathode exhaust gas (especially the exhaust air) out of the cathode spaces 12 of the fuel cell stack 10 and, if applicable, conveys it to an exhaust gas system.

Moreover, a fuel cell cooling system is being put forward, which is designated in its entirety by the reference numeral 40, which has a coolant path 41 in which the fuel cell stack 10 is integrated in a heat-exchanging manner. The coolant that is circulating in the coolant path 41 is conveyed by a coolant pump 42 driven by an electric motor. The temperature of the coolant, preferably water, a water-alcohol mixture or a water-ethylene glycol mixture, is controlled by a cooler 43 which, in case it is arranged in a vehicle, is normally a radiator equipped with an air fan. The cooler 43 has a sacrificial anode 44 and is connected to equipotential bonding 47 via a relay 45 that is controlled by a control unit 46. The relay 45 is controlled by means of the control unit 46 as a function of a detection of an insulation fault in the fuel cell cooling system 40. Thus, through the control of the relay 45, the connection of the cooler 43 to equipotential bonding 47 can be activated or deactivated. An insulation fault is detected, for example, by a conductivity measurement of the coolant or by an insulation resistance measurement in or on the fuel cell cooling system 40, for example, using a detection means 48. However, this information can also be provided by other suitable means in the fuel cell system 100, which are not shown here. The relay 45 is controlled based on the result of this measurement. Thus, for example, in case of an excessively high conductivity of the coolant, that is to say, if the measured value exceeds a prescribed value for the conductivity, the relay 45 establishes a connection between the cooler 43 and the equipotential bonding 47, as a result of which corrosion of the sacrificial anode 44 becomes possible, thereby protecting the cooler 43, which is made of less noble metals than the other components in the fuel cell cooling system 40. Moreover, in order to compensate for an ion input from the sacrificial anode 44 into the coolant, a deionization filter 49, for example, is arranged in the fuel cell cooling system 40. Once the fault that led to the elevated conductivity value has been remedied, the connection between the equipotential bonding 47 and the cooler 43 is once again deactivated, for example, by means of the control device 46. This can also be done manually in a repair shop. Control lines of the control unit 46 are not shown. Merely for the sake of illustration, an input 50 and an output 51 for the control lines on the control unit 46 are shown.

### LIST OF REFERENCE NUMERALS

100 fuel cell system
10 fuel cell stack
11 individual cell
12 anode space
13 cathode space
14 polymer electrolyte membrane
20 anode supply
21 anode supply path
22 anode exhaust gas path
23 fuel tank
30 cathode supply
31 cathode supply path
32 cathode exhaust gas path
40 fuel cell cooling system
41 coolant path
42 coolant pump
43 cooler
44 sacrificial anode
45 relay
46 control unit
47 equipotential bonding
48 detection means
49 deionization filter
50 input of the control unit
51 output of the control unit

What is claimed is:

1. A fuel cell system comprising:
a fuel cell stack; and
a fuel cell cooling system to cool the fuel cell stack, the fuel cell cooling system including a coolant path, the fuel cell stack integrated into the coolant path so as to transfer heat, at least one cooler or heat exchanger being arranged in the coolant path, the at least one cooler being connected via a connection so as to establish equipotential bonding, at least one control element being arranged in the connection of the at least one cooler or heat exchanger to the equipotential bonding.

2. The fuel cell system as recited in claim 1 wherein the at least one control element is an electrical switch.

3. The fuel cell system as recited in claim 1 wherein the electrical switch is a relay.

4. The fuel cell system as recited in claim 1 further comprising a control unit configured to control the at least one control element.

5. The fuel cell system as recited in claim 4 wherein the control unit has a detector for detecting insulation faults in the fuel cell cooling system.

6. The fuel cell system as recited in claim 1 wherein the at least one cooler is arranged in the coolant path and connected to at least one sacrificial anode.

7. The fuel cell system as recited in claim 1 further comprising a deionization filter.

8. A vehicle comprising the fuel cell system as recited in claim 1.
